(19) United States
(12) Patent Application Publication
(10) Pub. No.: US 2023/0132855 A1
(43) Pub. Date: May 4, 2023

(54) AUTOMATED LIDAR TARGET SIMULATION SCANNING SYSTEMS AND METHODS

(71) Applicant: Keysight Technologies, Inc., Santa Rosa, CA (US)

(72) Inventors: Chan Fong Tan, Penang (MY); Yenn Chang Tan, Penang (MY); Kok Eng Looi, Penang (MY); Chee Wei Liu, Penang (MY); Mong Long Ang, Penang (MY)

(21) Appl. No.: 17/513,118

(22) Filed: Oct. 28, 2021

(51) Int. Cl. G01S 7/497; G01S 7/481

(52) U.S. Cl. CPC G01S 7/497; G01S 7/4817

(57) ABSTRACT

An apparatus for testing a Lidar sensor includes a Lidar sensor platform, a target board including at least one vertically elongate surface facing in a direction of the Lidar sensor platform, and a base unit configured to position the target board to obtain a desired reflective property of the target board relative to an incident light scan emitted by a Lidar sensor mounted to the Lidar sensor platform during a target emulation test of the Lidar sensor.

### BACKGROUND

Modern cars increasingly incorporate so-called Advanced Driver Assistance Systems (ADAS). Among these, already well established are Emergency Brake Assist (EBA) and Lane Assist (LA) systems, with the goal being fully autonomous vehicles. All these systems require sensors to allow an electronic (or engine) control unit (ECU) of the vehicle to gather sufficient information indicative of the surrounding environment. Examples of commonly used and/or proposed ADAS sensors include ultrasonic sensors, video cameras, radar sensors and Lidar (or LiDAR) sensors.

Lidar, in particular, has the potential to become the main sensor for automotive autonomous driving systems due to its ability to provide accurate and long-range three-dimensional (3D) information for localization and mapping applications as well as for object detection collision avoidance. Lidar is a scanning process that rapidly measures the distance to objects at a number of different directions from the sensor. To cover the entire field of view, repetitive measurements are performed, and the results from different angles and time instances are stored as a point cloud. Generally, Lidar systems operate by generating light pulses from a light (laser) source fixed within a sensor. The light pulses may, for example, illuminate a spinning mirror that redirects the light in different azimuth angles from the sensor. Lidar may include multiple transmitters and receivers adapted to transmit and receive laser light to/from the surroundings to exact certain measurements, such as the distance of different objects from the Lidar.

One major challenge when developing ADAS equipped vehicles is to verify proper operations in the myriad of different scenarios which might occur in real traffic. To carry out this verification in real life is not a suitable possibility, as it is hard to achieve the required coverage (i.e. to actually test all relevant scenarios) and this would require too much time (thousands of hours). Additionally, all sensors must be verified in concert as it is important to verify that the ECU makes the right decision based on the data it is gathering from all sensors.

Lidar test solutions generally include an optical front-end module and base unit. The optical front-end module is operative to capture a laser beam emitted from a Lidar sensor under test, and to return a simulated reflection light signal back to the Lidar after delay processing by the base unit. A delay line module in the base unit operates to introduce delay into the simulated reflection signal according to, for example, the location (distance) of virtual objects (called targets) in a simulated drive scenario. It is difficult, however, to capture an entirety of the laser beam emission from the Lidar using a single optical front-end module. This is in part because the firing angle of the Lidar (e.g., about 20 to 30 degrees) may exceed the collection angle of the optical front-end module (e.g., about 5 degrees). While it may be possible to alter the optical lens system of the optical module to increase the collection angle, the result is degradation in focus characteristics which can result in performance errors. As such, in order to capture and accurately process all laser beam emissions, it may be necessary to provide multiple (e.g., 5 or more) optical modules. In addition to increasing costs, the provision of multiple optical modules significantly increases the complexity of the interface and synchronization with the base unit.

### SUMMARY

According to an aspect of the inventive concepts, an apparatus for testing a Lidar sensor is provided that includes a Lidar sensor platform, a target board including at least one vertically elongate surface facing in a direction of the Lidar sensor platform, wherein an angle of the elongate surface relative to the Lidar sensor platform is variable, and a base unit configured to set the angle of the elongate surface of the target board to obtain a desired reflective property of the target board relative an incident light scan emitted by a Lidar sensor mounted to the Lidar sensor platform during a target emulation test of the Lidar sensor.

A horizontal width of the at least one vertically elongate surface may be greater than a horizontal field of view coverage of the incident light scan on the target board.

The apparatus may include a first actuator configured to rotate the target board about a vertical axis of the target board. The apparatus may further include a second actuator configured to convey the target board in a linear direction to and from the Lidar sensor platform, and the base unit may further configured to control the second actuator to obtain a desired distance between the target board and the Lidar sensor during the target emulation test. The target board may be linearly movable by the second actuator in a range between a maximum distance to the Lidar sensor and a minimum distance to the Lidar sensor, where the maximum distance may 1.0 meters or less. The minimum distance may be 0.1 meters or more.

The vertically elongate surface may a retroreflective surface. The vertically elongate surface may be a diffused reflective surface. An absolute reflectance of the diffused reflective surface may be in a range of 5% to 80%.

A horizontal cross-section of the target board may be rectangular. A horizontal cross-section of the target board may be triangular. A horizontal cross-section of the target board may be polygonal.

The target board may be for emulating a target located a first distance from the Lidar sensor, and the apparatus may further comprises an automated scanning mechanism located adjacent the Lidar sensor platform for operating under control of the base unit to emulate a target located a second distance of the Lidar sensor, the second distance being greater than the first distance. The automated scanning mechanism may be configured to automatically control a position of an optical test module relative to the Lidar sensor during the target emulation test of the Lidar sensor. The first distance may be 1.0 meters or less.

The automated scanning mechanism may include a test module platform configured to support an optical test module such that an optical window of the optical test module faces in a direction towards the Lidar sensor under test, a vertical actuator configured to convey the test module platform relative to the sensor platform such that the optical test module moves in a vertical arc while the optical window of the optical test module faces the Lidar sensor, a horizontal actuator configured to convey the test module platform relative to the Lidar sensor such that the optical test module moves in a horizontal arc while the optical window of the optical test module faces the Lidar sensor, and a rotational actuator configured to rotate the optical test module about a vertical axis of the test module platform.

According to another aspect of the inventive concepts, an apparatus for testing a Lidar sensor is provided which includes a Lidar sensor platform, a first test sub-system including a target board is for emulating a target located a first distance from the Lidar sensor platform, and a second test sub-system including an automated scanning mechanism for emulating a target located a second distance from the Lidar sensor platform, the second distance being greater than the first distance.

### BRIEF DESCRIPTION OF THE DRAWINGS

The above and other aspects and features of the inventive concepts will become readily apparent from the detailed description the follows, with reference to the accompanying drawings, in which:

FIG. 1 is an external perspective view of an apparatus for automated positioning of an optical test module relative to a Lidar sensor during a target simulation test of the Lidar sensor according to an embodiment of the inventive concepts;

FIG. 2 is an internal perspective view of the apparatus of FIG. 1 according to an embodiment of the inventive concepts;

FIG. 3 is a schematic diagram of a Lidar sensor and the apparatus of FIG. 1 according to an embodiment of the inventive concepts;

FIGS. 4 and 5 are perspective views for reference in explaining vertical scanning of an optical test module of the apparatus of FIG. 1 according to an embodiment of the inventive concept;

FIGS. 6 and 7 are perspective views for reference in explaining horizontal scanning of an optical test module of the apparatus of FIG. 1 according to an embodiment of the inventive concepts;

FIG. 8 is a perspective view for reference in explaining detachable mounting of an optical test module in the apparatus of FIG. 1 according to an embodiment of the inventive concepts;

FIG. 9 is a perspective view of a test set-up including the apparatus of FIG. 1, a base unit and rotatable Lidar platform according to an embodiment of the inventive concepts;

FIG. 10 is a perspective view of a test set-up of FIG. 9 supplemented with a target board according to embodiments of the inventive concepts;

FIG. 11 is a perspective view for reference in describing a vertical field of view (VFOV) of the target board shown FIG. 10;

FIG. 12 is a perspective view for reference in describing a horizontal field of view (HFOV) of the target board shown FIG. 10;

FIG. 13 is a perspective view of an embodiment in which the target board shown in FIG. 10 is supported by a motorized rotary stage;

FIGS. 14, 15, 16 and 17 illustrate an embodiment of the inventive concepts in which the target board of FIG. 10 is movable along a rail to establish the distance between the target board and a Lidar DUT.

### DETAILED DESCRIPTION

Embodiments of the inventive concepts will now be described with reference to the accompanying drawings. It is emphasized that the various features illustrated in the drawings are not necessarily drawn to scale. In fact, the dimensions may be arbitrarily increased or decreased for clarity of discussion.

In the following detailed description, for purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for purposes of describing particular embodiments only and is not intended to be limiting. As used in the specification and appended claims, the singular forms of terms “a,” “an” and “the” are intended to include both singular and plural forms, unless the context clearly dictates otherwise. Additionally, the terms “comprises,” and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

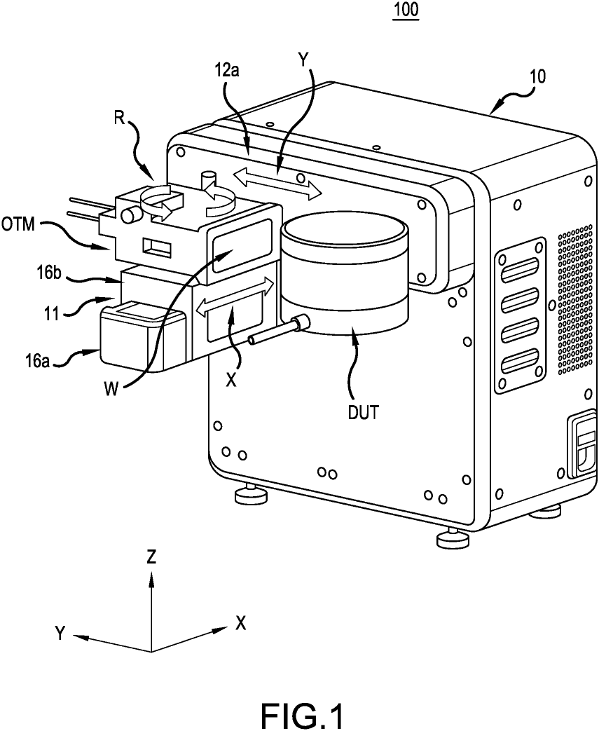

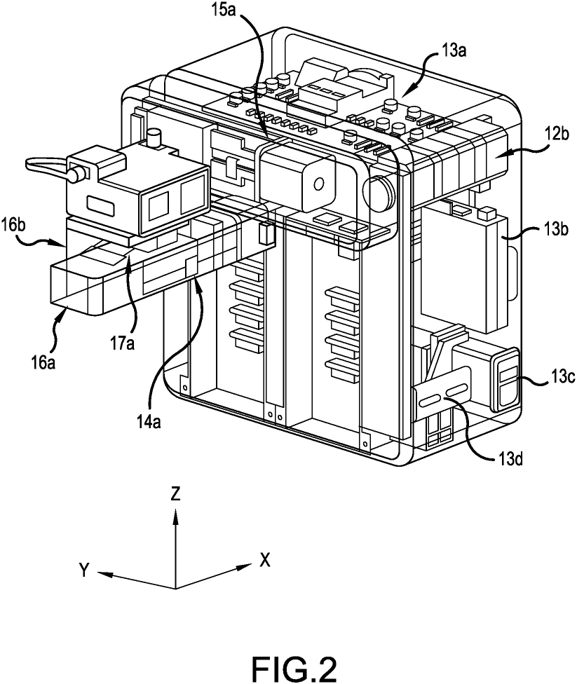

FIG. 1 is an external perspective an apparatus 100 for automated positioning of an optical test module relative to a Lidar sensor during a target simulation test of the Lidar sensor, and FIG. 2 is an internal perspective view of the same. For purposes of explanation and not limitation, the apparatus 100 may be referred to an automatic scanning system that forms part of a Lidar Target Simulator (LTS). Also for purposes of explanation and not limitation, directions parallel to an z-axis are referred to as vertical directions, directions parallel an x-axis are referred to as first horizontal directions, and directions parallel y-axis are referred to as second horizontal directions. The z-, x- and y-axes are all orthogonal to each other.

Referring to FIGS. 1 and 2, the apparatus 100 of the illustrated example includes a test module platform 11 configured to support an optical test module OTM. The optical test module OTM is supported by the test module platform 11 such that an optical window W of the optical test module OTM faces in a direction towards a Lidar sensor DUT. Although not shown in FIGS. 1 and 2, the Lidar sensor DUT may be supported by a sensor platform. The sensor platform may be separate and apart from the LTM 100, or may form an integral part of the LTM 100.

The test module platform 11 of this example includes a radial guide support 16a and an LTM stage 16b. The LTM stage 16b is slidably mounted in the first horizontal direction (x-axis direction) to the radial guide support 16a. As will be described below, an x-axis motor may be located within the radial guide support 16a to control movement of the LTM stage 16b along the first horizontal direction. In addition, as will also be described below, a rotational motor may be within the LTM stage 16b to rotate the optical test module OTM located thereon.

The LTM 100 further includes vertical, horizontal and rotational actuators, examples of which are described below. Each actuator may include one or more motors such as linear and/or rotational motors. Further, each actuator may include gears, shafts, guide mechanisms, arms, and the like. The vertical and horizontal actuators are configured to convey the optical test module OTM in vertical and horizontal directions, respectively, and the rotational actuator is configured to rotate the optical test module about a vertical axis of the test module platform.

In the example of the present embodiment, the vertical actuator includes a pivotally mounted arm 12a and a first rotational motor 12b that are configured to convey the test module platform 11 relative to the Lidar sensor DUT such that the optical test module OTM moves up-and-down in an arc generally along the vertical direction (i.e., an arc along the z-axis direction) while the optical window W of the optical test module OTM faces the Lidar sensor.

Still referring to FIGS. 1 and 2, the arm 12a of the vertical actuator has one end pivotally mounted to the housing 10 and a distal end that directly or indirectly supports the test module platform 11. In the example of the present embodiment, the previously described radial guide support 16a is fixed to the distal end of the arm 12a. The first rotational motor 12b of the vertical actuator rotates the arm 12a about a pivot point of the arm 12a. For example, the first rotational motor 12b may include rotatable shaft extending from within the module housing 10 to engage the arm 12a at the pivot point. As will be discussed later, the pivot point of the pivotally mounted arm 12a may be aligned in the first horizontal direction (i.e., the x-axis direction) with a focal point of the Lidar sensor DUT. Rotation of the motor shaft by the first rotational motor 12b causes the pivotally mounted arm 12a to rotate about the pivot point, which in turn conveys the test module platform 11 (and the optical test module OTM) along a vertical arc.

In the meantime, the afore-mentioned horizontal actuator of the example of the present embodiment includes an x-axis linear motor 14a and a y-axis linear motor 15a. These motors 14a and 15a are configured to jointly convey the test module platform 11 relative to the Lidar sensor DUT such that the optical test module OTM moves back-and-forth in an arc generally extending along the first horizontal direction (i.e., curved along the x-axis direction) while the optical window W of the optical test module OTM faces the Lidar sensor.

The x-axis linear motor 14a may be located at least partially within a radial guide support 16a. As previously mentioned, the LTM stage 16b is slidably mounted in the first horizontal direction (x-axis direction) to the radial guide support 16a. The x-axis motor 14a is configured to control movement of the LTM stage 16b along the first horizontal direction of the radial guide support 16a.

The y-axis linear motor 15a may be located within the arm 12a, and include a linear drive mechanism fixed to the radial guide support 16a through an opening in a wall of the arm 12a. The y-axis linear motor 15a is operative to convey the radial guide support 16a along a length of the arm 12a in the second horizontal direction (i.e., the y-axis direction).

The afore-mentioned rotational (R) actuator may be implemented by a second rotational motor 17a located, for example, in the LTM stage 16b and figured for rotational attachment to the optical test module OTM. The rotational motor 17a is operated to rotate the optical test module OTM about the vertical axis (i.e., the z-axis) of the LTM stage 16b. It is noted that a portion of the LTM stage 16b directly supporting the optical test module OTM may rotate together with the optical test module OTM. In an alternative embodiment, the optical test module OTM may include a rotational motor to achieve the desired rotation.

The LTM 100 of the illustrated example further includes a module housing 10 for supporting one or more of the previously described motors, as well as the arm 12/radial guide support16/LTM stage 16b assembly. In addition, the module housing 10 may include various circuits and electronic components for controlling an operation of the x-axis linear motor 14a, the y-axis linear motor 15a, the first rotational motor 12b, and the second rotational motor 17a to follow an optical scanning of the Lidar sensor DUT. Examples of such components are generally represented by reference numbers 13a, 13b, 13c and 13d in FIG. 2. The circuits/components may include a motherboard 13a having components such as a processor, RAM and ROM memories, bus systems, input/output (I/O) ports and the like. The circuits/components may further include a hard drive 13b and an AC power inlet 13c. The circuits/components may still further include external connectors 13d, such as serial and/or parallel data ports for communicating with an external device such as a base unit.

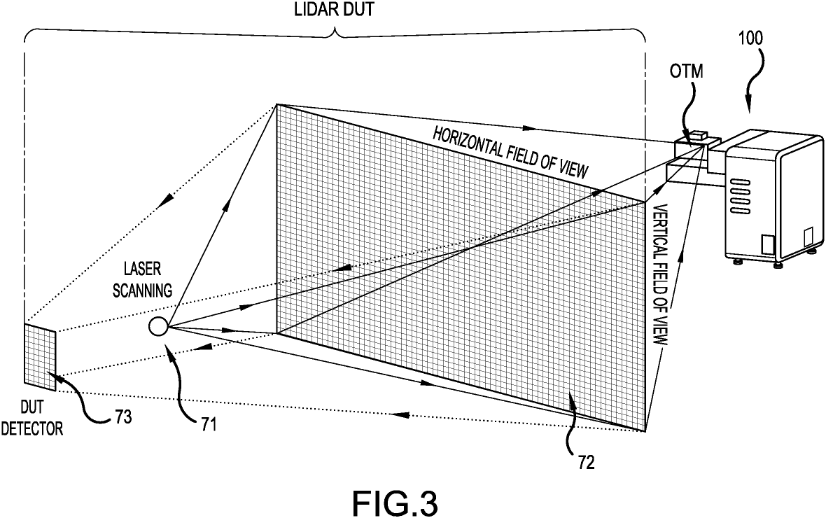

Reference is now made to the schematic view of FIG. 3 for describing the principal components of the Lidar DUT. As shown, while there are many types of Lidar sensors, they typically include a laser 71 emitting light beams throughout a given coverage area 72 defined by horizontal and vertical fields of view. For example, the emitted light beam may scan vertically and swept horizontally within the coverage area. The emitted beam is incident on the optical window W of the optical test module OTM mounted on the apparatus 100 as represented in the FIG. 3. The optical test module OTM is operative under control of a base unit (described later) to emit a simulated (delayed) reflection light of a target that is received by a DUT detector 73 of the Lidar DUT. As explained below, the actuator systems of the apparatus 100 are operative such that the optical window W of the optical test module OTM automatically moves along a scanning path of the Lidar sensor while controlling a distance and orientation between the optical window W of the optical test module OTM and the Lidar sensor DUT.

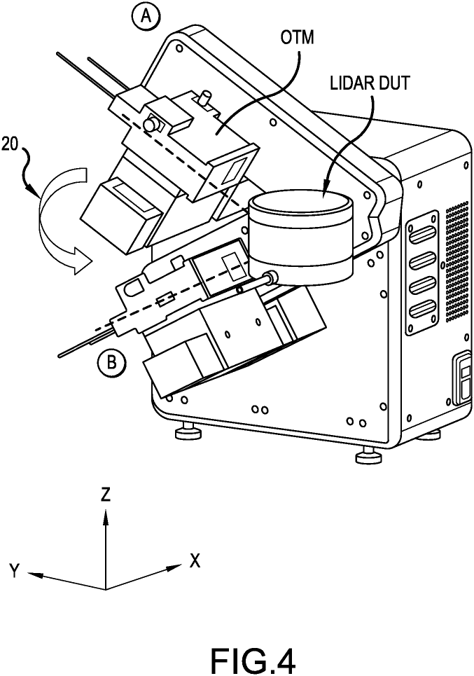

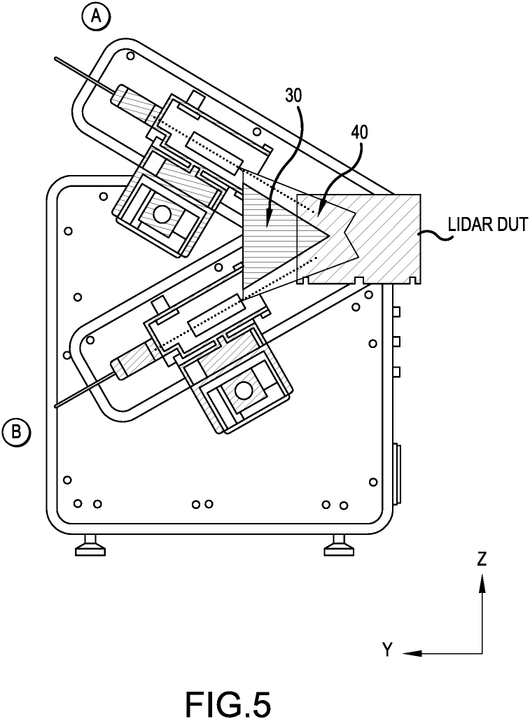

FIGS. 4 and 5 are perspective views for reference in explaining vertical scanning of an optical test module OTM of the apparatus of FIG. 1 according to an embodiment of the inventive concept.

FIGS. 4 and 5 show the arm 12 of apparatus 100 at an upper scanning position A and a lower scanning position B. As the arm 12 is scanned between A and B, it will be apparent that the optical test module OTM travels in a vertical arc. Reference number 30 of FIG. 5 represents the vertical field of view coverage angle of the Lidar DUT, which is much greater than the area of the optical test module OTM capture angle 40. By moving the optical test module OTM vertically, the coverage of the light beam acceptance angle can be increased (e.g., to 60 degrees) to fully encompass the coverage angle of the Lidar DUT. Further, since the vertical movement is arced, the distance between the optical window W of the optical test module OTM and the focal point of the Lidar DUT is substantially controlled to be constant, thus improving performance. In an example embodiment, the pivot point of the pivotally mounted arm 12 is aligned in a horizontal direction with a focal point of the Lidar sensor DUT. Alternatively, or in addition, a center point defined by the vertical arc may correspond to the focal point of the Lidar sensor.

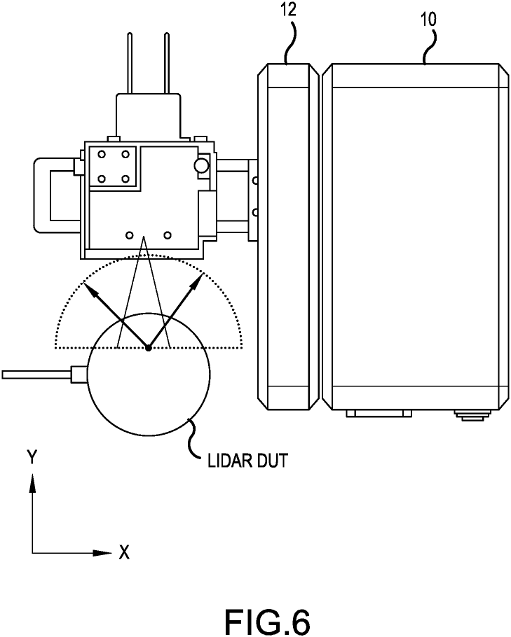

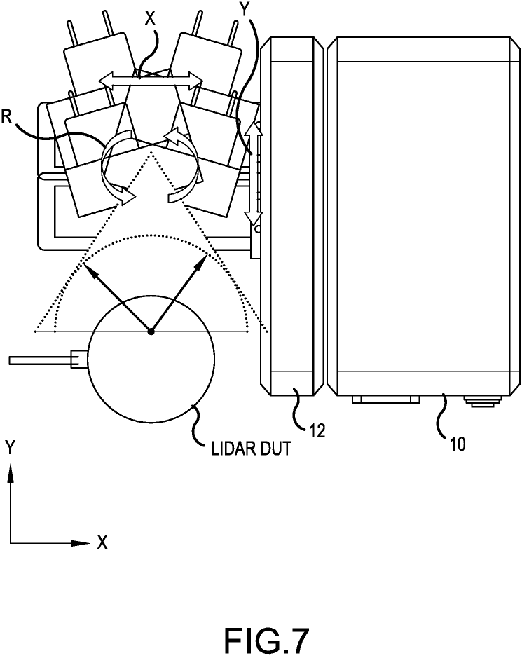

FIGS. 6 and 7 are perspective views for reference in explaining horizontal scanning of an optical test module OTM of the apparatus of FIG. 1 according to an embodiment of the inventive concept.

Referring to FIGS. 6 and 7, the afore-described x-axis and y-axis motors are driven to convey the optical test module OTM in a horizontal arc 55. By moving the optical test module OTM horizontally in this manner, the coverage of the light beam acceptance angle 40 can be increased (e.g., to 60 degrees) to fully encompass the coverage angle of the Lidar sensor DUT (as is represented by reference number 55 in FIG. 7). Further, by rotating (R) the optical test module OTM about the vertical axis, the optical window W can be made to face the Lidar sensor DUT as the optical test module OTM travels along the horizontal arc 55. In other words, the optical window W may be oriented tangentially the horizontal arc 55 as the optical test module OTM moves in the horizontal arc 55. In an embodiment, a center point C of the horizontal arc 55 corresponds to a focal point of the Lidar sensor DUT.

The apparatus 100 described above provides a mechanism for the optical test module OTM to automatically move along four (4) axes in order to effectively increase a capture angle of the optical test module OTM, and in order to maintain a distance and orientation between the optical test module OTM and Lidar sensor DUT. The control system may store each coordinate of the 4-axis system relative to each scanning coordinate of the Lidar sensor DUT. In the manner, the optical test module OTM may capture any scanning beam of the Lidar sensor DUT at that same scanning distance and orientation.

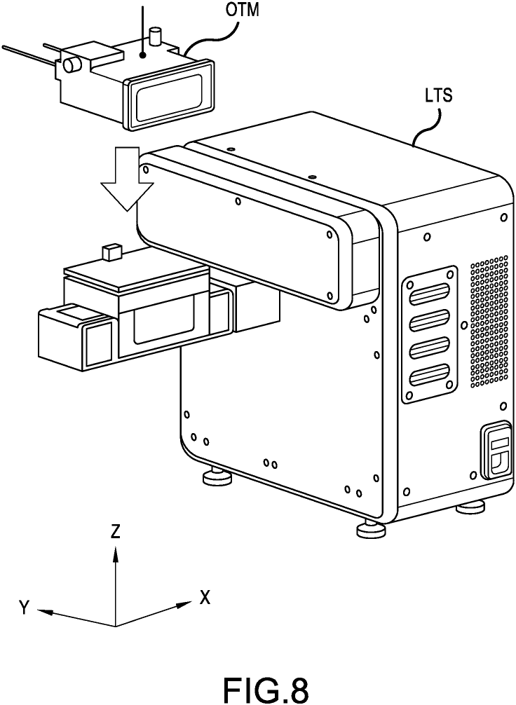

FIG. 8 is a perspective view for reference in describing the detachability of the optical test module OTM to the LTS 100 according to an embodiment of the inventive concepts.

Referring to FIG. 8, in an embodiment of the inventive concepts, the test module platform 11 (or the LTM stage 16b) may be configured for detachably mounting of any of plural different types of optical test modules OTMs. This may be useful in readily adapting the apparatus 100 to different types of the Lidar sensors. The different types of optical test modules OTMs may include those including a single optical window and a single sub-module communicating with a base unit, and/or those including two or more optical windows and two or more sub-modules communicating with the base unit. That is, the test module platform 11 (or the LTM stage 16b) may be configured to support an optical test module OTM having a single sub-module and a single optical window, where the sub-module is for both receiving at the optical window a light scan emitted by the Lidar sensor and transmitting a corresponding detection signal to a base unit, and emitting from the optical window a simulated target reflection of the light scan to the Lidar sensor based on a corresponding reflection signal received from the base unit. Alternative, or in addition, the test module platform 11 (or the LTM stage 16b) may be configured to support an optical test module OTM comprising separate first and second sub-modules and respective first and second optical windows, where the first sub-module is for receiving at the first optical window a light scan emitted by the Lidar sensor and transmitting a corresponding detection signal to the base unit, and the second sub-module is for emitting from the second optical window a simulated target reflection of the light scan to the Lidar sensor based on a corresponding reflection signal received from the base unit.

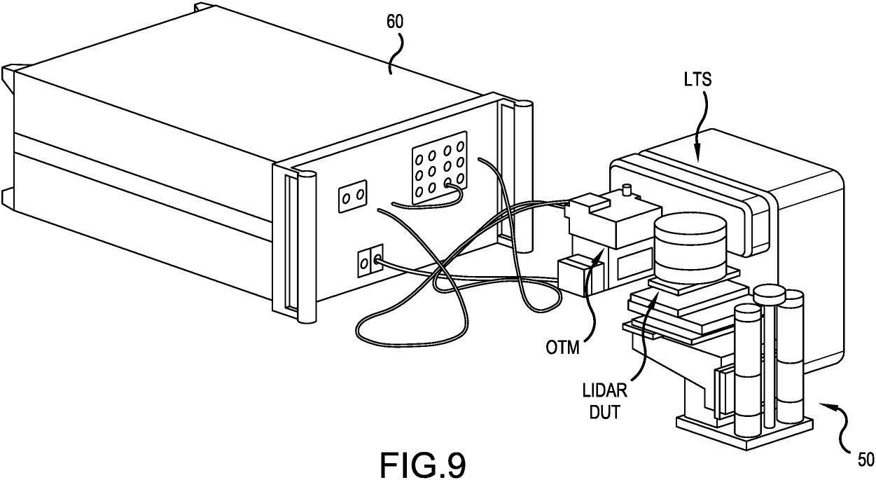

FIG. 9 is a perspective view of a test set-up including the apparatus 100 of FIG. 1, together with a base unit and rotatable Lidar platform according to an embodiment of the inventive concepts.

The base unit 60 is configured to control an operation of the optical test module OTM mounted on the test module platform of the apparatus 100 according to a target simulation program executed for testing the Lidar sensor supported by a rotatable Lidar platform 50. Briefly, the base unit 60 controls the optical test module OTM to receive a light scan emitted by the Lidar sensor DUT, to delay the light according to characteristics of a simulated target, and to emit a simulated target reflection of the light scan to the Lidar sensor. An example of the base unit 60 is described in commonly assigned U.S. Pat. application no. 17/126,085, filed Dec. 18, 2020, the disclosure of which is incorporated herein in its entirety by reference.

During the target simulation carried out by the base unit 60 and optical test module OTM, the actuator system of the apparatus 100 is driven such that the optical window W of the optical test module OTM automatically moves along a scanning path of the Lidar sensor DUT while controlling a distance and orientation between the optical window W of the optical test module OTM and the Lidar sensor DUT. As mentioned previously, this can be achieved by storing in advance each coordinate of the 4-axis system of the optical test module OTM relative to each scanning coordinate of the Lidar sensor DUT.

FIG. 9 also shows a Lidar sensor platform 50 for supporting the Lidar sensor DUT during testing, as well as a rotational mechanism including a motor for rotating the Lidar sensor DUT. In an embodiment of the inventive concepts, the horizontal and vertical position of the Lidar sensor DUT are fixed, but the Lidar sensor DUT can be automatically rotated if desired. In addition, in an embodiment of the inventive concepts, the Lidar sensor platform can be configured for mounting of any of plural different types of Lidar sensors. This allows for the sharing of the same scanning automation platform for different types of Lidar sensors.

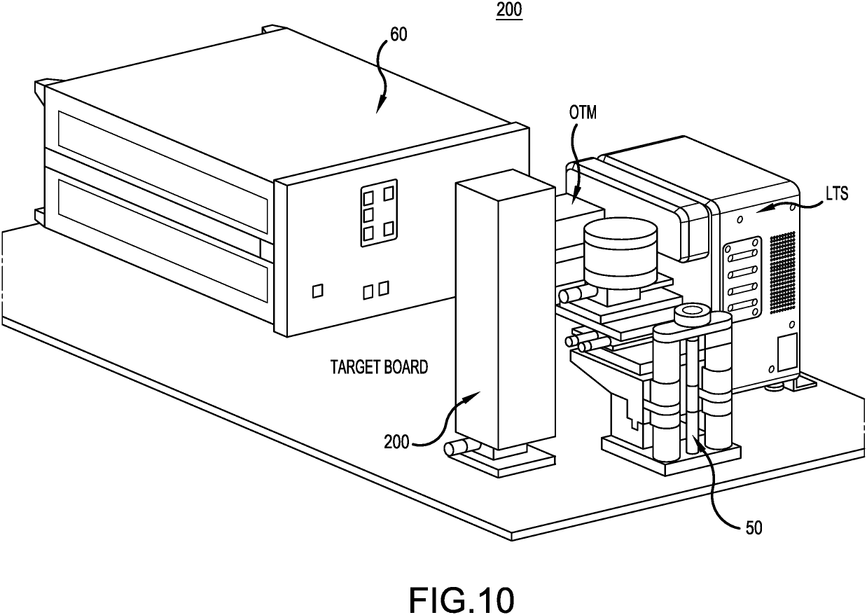

FIGS. 10 through 16 are perspective views of the test set-up of FIG. 9 supplemented with a target board 200 according to embodiments of the inventive concepts. In FIGS. 10 through 16, previously described elements are referenced with like reference characters, and a detail description of such elements is omitted below to avoid redundancy in the description.

The apparatus described previously in connection with FIGS. 1 through 9 exhibit clear benefits in simulating a relatively long distance target, but may potentially be limited in the simulation of relative short target distances of, for example, 0.1 m or less. This limitation may be the result of cabling and system delays which may exceed, for example, 0.6 ns. To overcome this potential limitation, the embodiment of FIG. 10 presents a hybrid system of a physical target board together with the previously described optical test module (OTM) which in tandem can simulate both very short and long distances. For relatively long-distance simulation (e.g., 2 m to 300 m or above), it may be more practical to perform the test/calibration using the scanning mechanism of the OTM to collect and return simulated delay signals and power intensities from/to any horizontal and vertical angle of a Lidar DUT. On the other hand, for relatively short-distance simulation (e.g. 2 m or less), it may be more practical to perform the test/calibration using the target board 200 described next.

Referring to the example of FIG. 10, an apparatus 200 is shown which includes a Lidar test simulator (LTS) made up of a base unit 60, a rotatable Lidar platform 50 and an optical test module (OTM) which operate as described previously to perform Lidar test/calibration of relatively long-distance simulations. In addition, the apparatus 200 includes a target board 200 which may be located adjacent the platform 50.

The target board 200 constitutes a physical target that reflects power emitted by the Lidar sensor (or DUT) back to the Lidar sensor for detection. As mentioned above, this physical target board 200 may be used to test/calibrate the Lidar DUT at short distances based on the reflectivity detection capabilities of the Lidar DUT. The shape of the target board 200 is not limited, and indeed, it may have a variety of different shapes. As examples, the target board 200 may be a flat board of relatively small thickness having two vertically extending polygonal (e.g., rectangular) surfaces opposite one another, a board having a triangular cross-section having three vertically extending polygonal (e.g., rectangular) surfaces, a board having a rectangular or square cross-section having four vertically extending polygonal (e.g., rectangular) surfaces, a board having a polygonal cross-section having five or more vertically extending polygonal (e.g., rectangular) surfaces, and so on. In example embodiments, each polygonal surface (or end face) of the target board 200 is elongate and extends lengthwise in a vertical direction (z-axis direction). Also in example embodiments, each surface may be customized to have retro or diffused reflection type characteristics. For diffused reflection, the reflectance level may be from 5% to 80% or higher. During testing, the Lidar DUT will transmit one or more beams across a horizontal field of view (HFOV) and vertical field of view (VFOV) coverage area of one or more surfaces of the target board 200. A target board 200 with a higher percentage of reflectance level will reflect more power back to Lidar DUT. In some embodiments, the HFOV and VFOV coverage area extends over one surface of the target board 200. In other embodiments, the HFOV and VFOV coverage area extends over two or more surfaces of the target board 200.

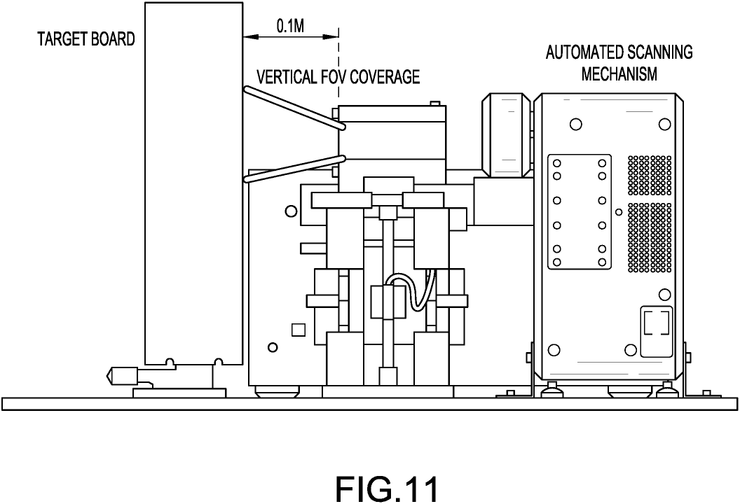

FIG. 11 is a perspective side-view for reference in describing a VFOV coverage area. In this example, the target board 200 is assumed to be located 0.1 m from the Lidar DUT. FIG. 11 shows the effective Vertical field of view (VFOV) coverage angle of Lidar DUT when it is facing to physical target board at a short distance. Preferably, the height of the target board 200 is sufficient to have full VFOV coverage at given test distances between the target board 200 and the Lidar DUT.

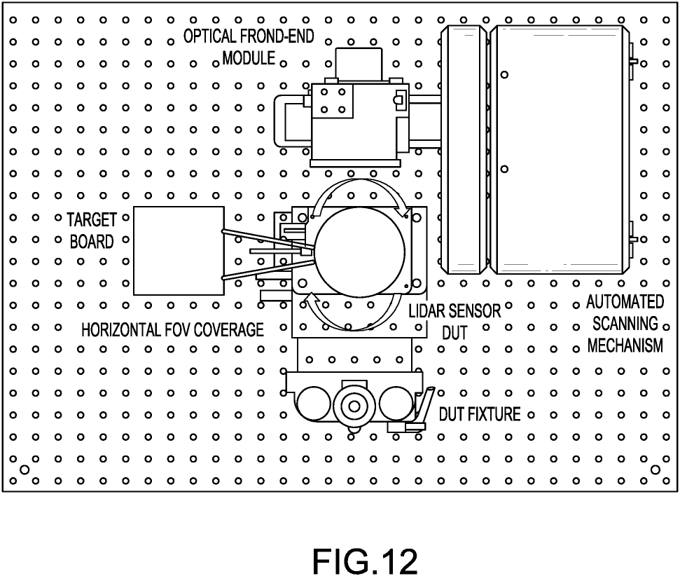

FIG. 11 is a perspective top-view for reference in describing a HFOV coverage area. In this example, the target board 200 is again assumed to be located 0.1 m from the Lidar DUT. FIG. 11 shows the effective Horizontal field of view (HFOV) coverage angle of Lidar DUT when it is facing to physical target board at a short distance. In some embodiments, the width of the target board 200 is sufficient to have full HFOV coverage at given test distances between the target board 200 and the Lidar DUT. In other embodiments, where the width of target board 200 only partially covers the HFOV of the Lidar DUT, the motorized rotatable platform 50 may rotate the Lidar DUT clockwise and counterclockwise (when view from the top as represented by the curved arrows of FIG. 12) to scan every horizontal angle of the Lidar DUT such that all emitted beams are incident on the target board 200. That is, during the short distance test/calibration, a motorized rotary stage of the platform 50 may turn the Lidar DUT clockwise and counterclockwise (or back and forth) to scan the Lidar DUT at a horizontal angle when it is facing perpendicular to physical target board 50.

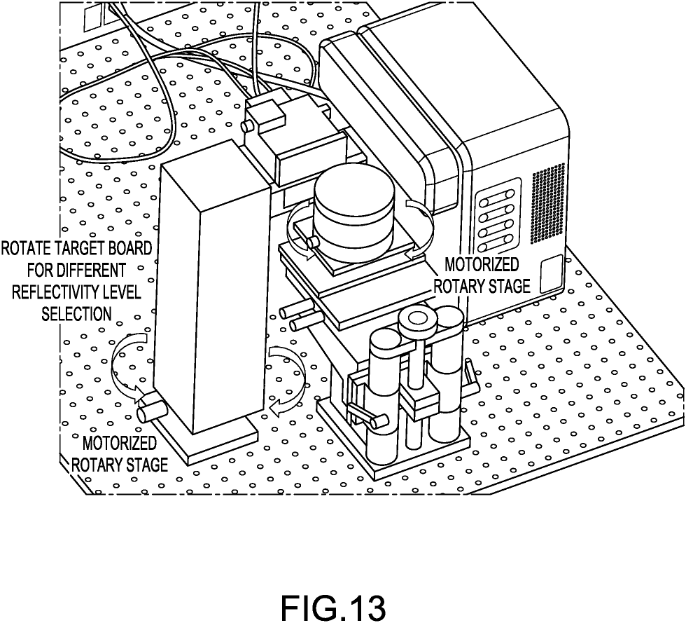

FIG. 13 illustrates another embodiment in which the reflectivity of the target board 200 is controlled. That is, in the example of this embodiment, the target board 200 is support by a motorized rotary stage 55. In operation, the stage 55 may rotate the target board 200 back and forth (clockwise and counterclockwise when view from the top) to stop and align one or two sides of target board 200 so as to face the Lidar DUT during the test/calibration. In addition, as desired reflectivity level may be obtained by controlling an angle at which the one or two sides of the target board 200 face the Lidar DUT during testing.

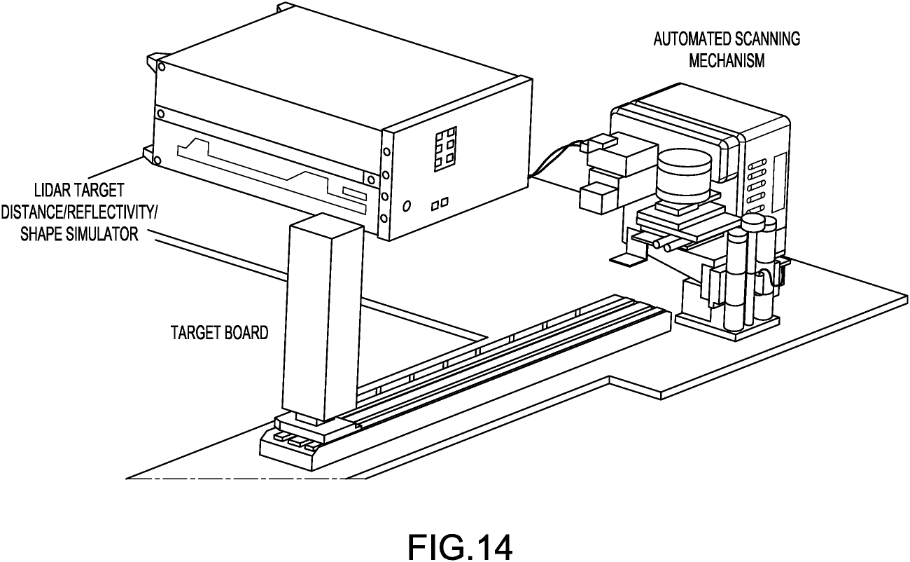

FIGS. 14 through 16 illustrate another embodiment in which the distance between the Lidar DUT and the target board 200 may be controlled. In the example of this embodiment, the target board 500 is positioned along a rail 56 to set the distance between the target board 500 and Lidar DUT. Here, the positioned of the Lidar DUT may be fixed, but the inventive concepts are not limited in this manner. Also, as a nonlimiting example, the target board 200 may be positioned along the rail 56 at a distance range of 0.1 m to 1.0 m or more from the Lidar DUT. The target board 200 may be manually positioned along the rail 56. Alternatively, or in addition, the stage 55 upon which the target board 200 is supported may be motorized to travel to a desired position along the rail 56.

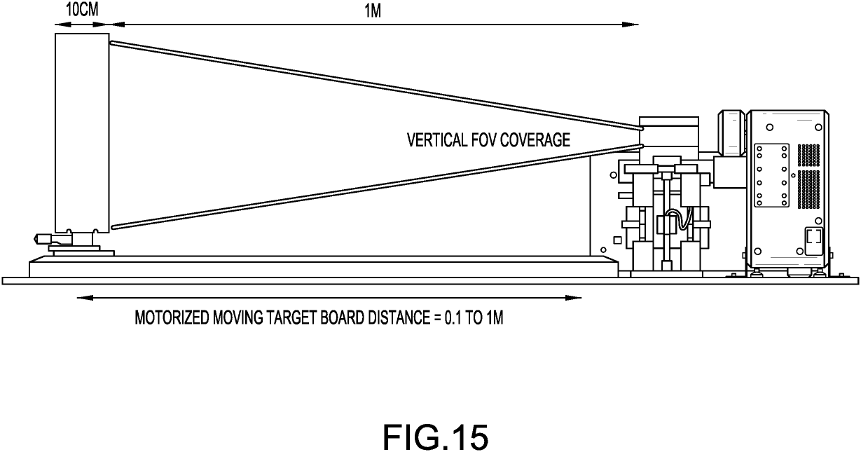

As best shown in the side view of FIG. 15, the height of the target board 200 is preferably sufficient to have full VFOV coverage at the maximum distances between the target board 200 and the Lidar DUT. In this case, full VFOV coverage is achieved at any position of the target board 200 along the rail 56.

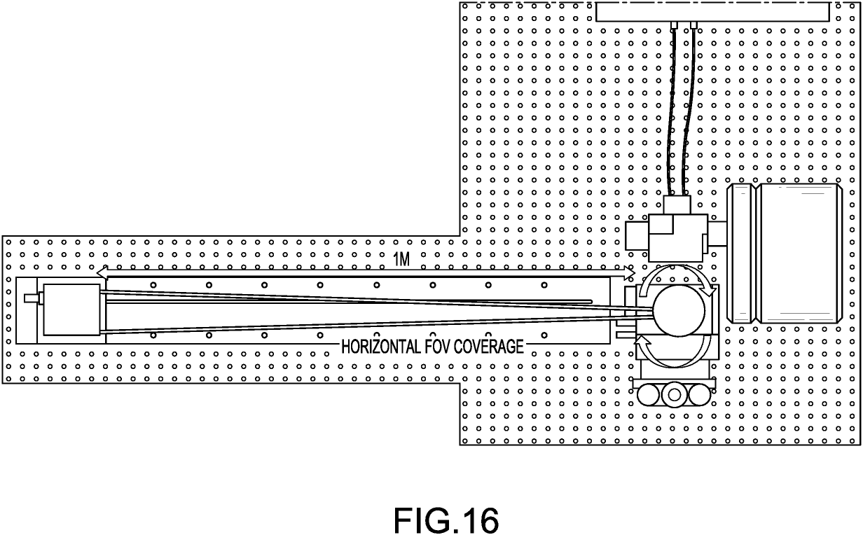

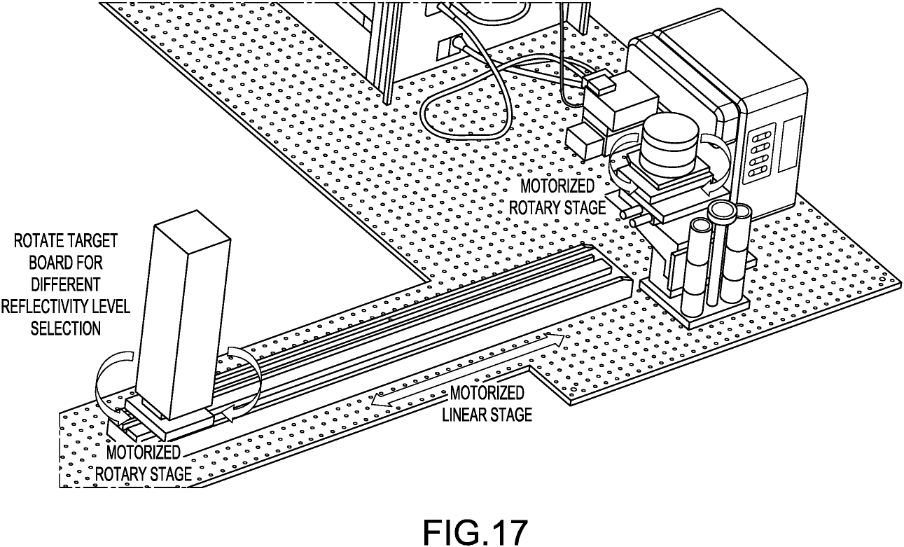

Further, as best shown the top view of FIG. 16, the width of the target board 200 is preferably sufficient to have full HFOV coverage at the maximum distances between the target board 200 and the Lidar DUT. In this case, full HFOV coverage is achieved at any position of the target board 200 along the rail 56. Alternatively, as described previously, where the width of target board 200 only partially covers the HFOV of the Lidar DUT at the maximum distance, the motorized rotatable platform 50 may rotate the Lidar DUT clockwise and counterclockwise (when view from the top as represented by the curved arrows of FIG. 16) to scan every horizontal angle of the Lidar DUT such that all emitted beams are incident on the target board 200.

It is noted that embodiments of the inventive concept include test set-ups which operate using the target board 200, but without also using or equipping the test apparatus with the optical test module OTM (or automated scanning mechanism). Further, the maximum distance of the measurement range of the target board 200 is not limited to the examples described previously herein. Likewise, the minimum and maximum simulated distances of the measurement range of the OTM is not limited to the examples described previously herein.

While representative embodiments are disclosed herein, one of ordinary skill in the art appreciates that many variations that are in accordance with the present teachings are possible and remain within the scope of the appended claim set. The invention therefore is not to be restricted except within the scope of the appended claims.

What is claimed is:

1. An apparatus for testing a Lidar sensor, comprising:
a Lidar sensor platform;
a target board including at least one vertically elongate surface facing in a direction of the Lidar sensor platform, wherein an angle of the elongate surface relative to the Lidar sensor platform is variable; and
a base unit configured to set the angle of the elongate surface of the target board to obtain a desired reflective property of the target board relative to an incident light scan emitted by a Lidar sensor mounted to the Lidar sensor platform during a target emulation test of the Lidar sensor.

2. The apparatus of claim 1, wherein a horizontal width of the at least one vertically elongate surface is greater than a horizontal field of view coverage of the incident light scan on the target board.

3. The apparatus of claim 1, further comprising a first actuator configured to rotate the target board about a vertical axis of the target board to set the angle of the elongate surface of the target board relative to the Lidar sensor platform.

4. The apparatus of claim 3, further comprising a second actuator configured to convey the target board in a linear direction to and from the Lidar sensor platform, and
wherein the base unit is further configured to control the second actuator to obtain a desired distance between the target board and the Lidar sensor during the target emulation test.

5. The apparatus of claim 4, wherein the target board is linearly movable by the second actuator in a range between a maximum distance to the Lidar sensor and a minimum distance to the Lidar sensor,
wherein the maximum distance is 1.0 meters or less.

6. The apparatus of claim 5, wherein the minimum distance is 0.1 meters or more.

7. The apparatus of claim 1, wherein the vertically elongate surface is a retroreflective surface.

8. The apparatus of claim 1, wherein the vertically elongate surface is a diffused reflective surface.

9. The apparatus of claim 8, wherein an absolute reflectance of the diffused reflective surface is in a range of 5% to 80%.

10. The apparatus of claim 1, wherein a horizontal cross-section of the target board is rectangular.

11. The apparatus of claim 1, wherein a horizontal cross-section of the target board is triangular.

12. The apparatus of claim 1, wherein a horizontal cross-section of the target board is polygonal.

13. The apparatus of claim 1, wherein the target board is for emulating a target located a first distance from the Lidar sensor,
wherein the apparatus further comprises an automated scanning mechanism located adjacent the Lidar sensor platform for operating under control of the base unit to emulate a target located a second distance of the Lidar sensor, the second distance being greater than the first distance,
wherein the automated scanning mechanism is configured to automatically control a position of an optical test module relative to the Lidar sensor during the target emulation test of the Lidar sensor.

14. The apparatus of claim 13, wherein the first distance is 1.0 meters or less.

15. The apparatus of claim 13, wherein the automated scanning mechanism comprises:
a test module platform configured to support an optical test module such that an optical window of the optical test module faces in a direction towards the Lidar sensor under test;
a vertical actuator configured to convey the test module platform relative to the sensor platform such that the optical test module moves in a vertical arc while the optical window of the optical test module faces the Lidar sensor;
a horizontal actuator configured to convey the test module platform relative to the Lidar sensor such that the optical test module moves in a horizontal arc while the optical window of the optical test module faces the Lidar sensor; and
a rotational actuator configured to rotate the optical test module about a vertical axis of the test module platform.

16. An apparatus for testing a Lidar sensor, comprising:
a Lidar sensor platform;
a first test sub-system including a target board is for emulating a target located a first distance from the Lidar sensor platform, and
a second test sub-system including an automated scanning mechanism for emulating a target located a second distance from the Lidar sensor platform, the second distance being greater than the first distance.
